(19) United States
(12) Patent Application Publication
(10) Pub. No.: US 2023/0325622 A1
(43) Pub. Date: Oct. 12, 2023

(54) IMAGE FORMING DEVICE AND WARNING METHOD

(71) Applicant: Toshiba Tec Kabushiki Kaisha, Tokyo (JP)

(72) Inventor: Takashi TOMIYAMA, Sunto Shizuoka (JP)

(73) Assignee: Toshiba Tec Kabushiki Kaisha, Tokyo (JP)

(21) Appl. No.: 18/333,847

(22) Filed: Jun. 13, 2023

Related U.S. Application Data
(63) Continuation of application No. 17/681,554, filed on Feb. 25, 2022.
Application No. 17/681,554 is a continuation of application No. 17/025,867, filed on Sep. 18, 2020, now abandoned.

(51) Int. Cl. G06K 15/00; G06K 7/10; G06K 15/16

(52) U.S. Cl. CPC G06K 15/408; G06K 7/10366; G06K 15/16

(57) ABSTRACT

An image forming device includes a wireless tag communication device and a controller. The wireless tag communication device is configured to acquire identification information to identify a wireless tag from the wireless tag provided in a sheet. The controller is configured to acquire dispensing information required to write to the wireless tag and perform a warning process by using the acquired dispensing information and the acquired identification information, upon the dispensing condition not being satisfied.

### CROSS-REFERENCE TO RELATED APPLICATIONS

This application is a continuation of U.S. application Ser. No. 17/681,554, filed Feb. 25, 2022, which is a continuation of U.S. application Ser. No. 17/025,867, filed Sep. 18, 2020, the entire contents of which are incorporated herein by reference.

### FIELD

Embodiments described herein relate generally to an image forming device and a warning method.

### BACKGROUND

An image forming device that forms an image on a sheet placed on a paper feed cassette or a manual feeding tray has been widely used. The sheet may be provided with a wireless tag. In order to read and write the information to the wireless tag of the sheet, the image forming device is provided with a sheet conveyance device including a wireless tag communication device. However, writing may fail depending on the wireless tag provided in the sheet to be a dispensing target. For example, writing cannot be performed if the capacity of a memory of the wireless tag is smaller than the size of data to be written. In such an image forming device, writing failure to the wireless tag cannot be previously prevented in some cases.

### BRIEF DESCRIPTION OF THE DRAWINGS

FIG. 1 is a diagram illustrating an example of a configuration of an image forming device according to a first embodiment;

FIG. 2 is a block diagram illustrating an internal configuration of an image forming control unit (controller) according to at least one embodiment;

FIG. 3 is a flowchart illustrating a flow of a warning process performed by the image forming device according to at least one embodiment;

FIG. 4 is a diagram illustrating an example of a characteristic information table in which characteristic information is registered according to a second embodiment;

FIG. 5 is a flowchart illustrating a flow of a warning process performed by the image forming device according to at least one embodiment; and

FIG. 6 is a flowchart illustrating a flow of a determination process according to at least one embodiment.

### DETAILED DESCRIPTION

In general, according to at least one embodiment, an image forming device includes a wireless tag communication device and a control unit (controller). The wireless tag communication device is configured to acquire identification information to identify a wireless tag in a sheet. The control unit is configured to acquire dispensing information required to write to the wireless tag and to perform a warning process by using the acquired dispensing information and the acquired identification information, upon the dispensing condition not being satisfied.

Hereinafter, an image forming device and a warning method of the embodiment are described with reference to the drawings.

The image forming device of at least one embodiment can previously prevent the writing failure to a wireless tag. In the following description, configurations having the same or similar functions are designated by the same reference numerals. The description of the duplicated configuration may be omitted.

### (Overview)

First, an outline of processing performed by the image forming device of at least one embodiment is described. The sheets used in the following embodiments are described assuming that a wireless tag is provided. Examples of the sheets include paper or a label on which characters, images, and the like are formed. When the sheet is dispensed, the image forming device acquires identification information with which the wireless tag can be identified, from the wireless tag provided in the sheet. The identification information with which the wireless tag can be identified is referred to as tag identification (TID). For example, the identification information with which the wireless tag can be identified is the model number of the wireless tag. In the following description, as the identification information with which the wireless tag can be identified, a model number is exemplified.

The image forming device acquires dispensing information required for writing to the wireless tag when the sheet is dispensed from the outside. Specifically, the image forming device may acquire the dispensing information from metadata of data (hereinafter, referred to as “print data”) to be a printing target. For example, the image forming device acquires the print data from an external recording medium such as a universal serial bus (USB) memory or an SD card or an external communication device. The dispensing information includes at least a model number and write data to the wireless tag.

If the dispensing condition is not satisfied, the image forming device performs a warning process based on the acquired model number and the acquired dispensing information. The dispensing condition is a condition for permitting the dispensing. For example, the dispensing condition may be a condition in which the acquired model number and the model number included in the dispensing information agree with each other. The warning process is a process for notifying a user that the dispensing condition is not satisfied, and for example, the warning process may be a process of displaying an error on a display unit.

As in the above process, the image forming device performs a warning process if the dispensing condition is not satisfied. Accordingly, a warning can be made to a user before writing to the wireless tag. Therefore, the writing failure to the wireless tag can be previously prevented.

Hereinafter, the specific configuration relating to the image forming device is described.

### First Embodiment

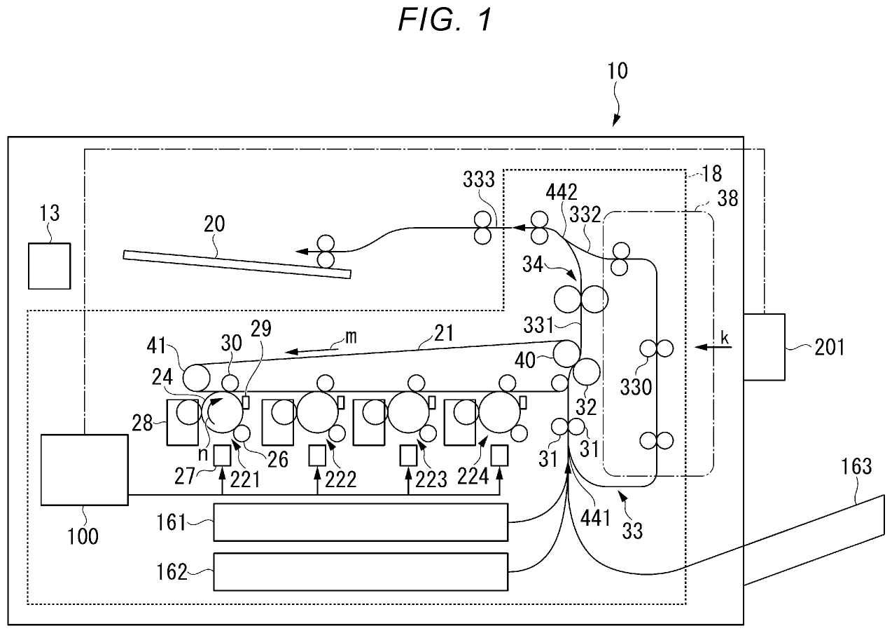

FIG. 1 is a diagram illustrating an example of the configuration of an image forming device 10 according to a first embodiment.

The image forming device 10 includes a control panel 13, a wireless tag communication device 201, and a printer unit 18. The printer unit 18 includes an image forming control unit 100, paper feed cassettes 161 and 162, and the like. The image forming control unit 100 controls the control panel 13, the wireless tag communication device 201, and the printer unit 18. The image forming control unit 100 controls the conveyance of the sheet in the printer unit 18. The controlling of the conveyance of the sheet is to control the conveyance timing of the sheet, the stop position of the sheet, and the conveyance speed of the sheet, and the like.

The control panel 13 includes a display unit (display) and an operation unit. The display unit may be a display device such as a liquid crystal display or an organic electro luminescence (EL) display. The display unit displays error information in response to various items of information and various warning processes relating to the setting of the image forming device 10 in response to the controlling of the image forming control unit 100. The error information in response to the warning process includes, for example, notification indicating that the dispensing condition is not satisfied and information indicating the reason why the dispensing condition is not satisfied.

The paper feed cassettes 161 and 162 store sheets provided with wireless tags. The paper feed cassettes 161 and 162 can also store sheets which are not provided with wireless tags. As the sheet, for example, a material such as paper or a plastic film is used.

The printer unit 18 (printer) performs an operation for forming an image. For example, the printer unit 18 forms an image indicating image data on a sheet. In the following description, forming an image on a sheet is also referred to as “printing”. In at least one embodiment, the printer unit 18 is a device for fixing a toner image, but the embodiment is not limited thereto. For example, it may be an inkjet type printer.

The printer unit 18 includes an intermediate transfer belt 21. The printer unit 18 supports the intermediate transfer belt 21 with a driven roller 41, a backup roller 40, and the like. The printer unit 18 rotates the intermediate transfer belt 21 in an arrow m direction. The printer unit 18 includes four image forming stations 221, 222, 223, and 224. The image forming stations 221, 222, 223, and 224 correspond to yellow (Y), magenta (M), cyan (C), and black (K), respectively. The image forming stations 221, 222, 223, and 224 are disposed in the rotation direction of the intermediate transfer belt 21 on the lower side of the intermediate transfer belt 21.

Hereinafter, the description is made with an example of the image forming station 221 of yellow (Y) among the image forming stations 221, 222, 223, and 224. Since the image forming stations 222, 223, and 224 have the same configurations as the image forming station 221, the detailed description thereof is omitted.

The image forming station 221 includes a charging charger 26, an exposure scanning head 27, a developing device 28, and a photoconductor cleaner 29. The charging charger 26, the exposure scanning head 27, the developing device 28, and the photoconductor cleaner 29 are disposed around a photoconductor drum 24 that rotates in an arrow n direction.

The image forming station 221 includes a primary transfer roller 30. The primary transfer roller 30 is disposed to face the photoconductor drum 24 via the intermediate transfer belt 21.

The charging charger 26 uniformly charges the photoconductor drum 24. The exposure scanning head 27 exposes the uniformly charged photoconductor drum 24 and forms an electrostatic latent image on the photoconductor drum 24. The developing device 28 develops an electrostatic latent image on the photoconductor drum 24 by using a two-component developer formed with a toner and a carrier.

The primary transfer roller 30 primarily transfers the toner image formed on the photoconductor drum 24 to the intermediate transfer belt 21. The primary transfer roller 30 of each of the image forming stations 221, 222, 223, and 224 primarily transfers the toner image to the intermediate transfer belt 21 so that a color toner image is formed on the intermediate transfer belt 21. The color toner image is a toner image formed by sequentially overlapping toner images of yellow (Y), magenta (M), cyan (C), and black (K). The photoconductor cleaner 29 removes toner remaining on the photoconductor drum 24 after the primary transfer.

The printer unit 18 includes a secondary transfer roller 32. The secondary transfer roller 32 is disposed to face the backup roller 40 via the intermediate transfer belt 21. The secondary transfer roller 32 secondarily transfers the color toner image on the intermediate transfer belt 21 to the sheet, collectively. In the above description, the “toner image” may be any one of a color toner image and a toner image of only one color. The toner image may be a toner image using a decolorable toner.

A conveyance path 33 is a path through which the sheet is conveyed through a plurality of conveyance rollers (for example, a conveyance roller 330 and the like). The conveyance path 33 includes a first conveyance path 331, a second conveyance path 332, and a third conveyance path 333. The first conveyance path 331 is a conveyance path from a confluence portion 441 to a branch portion 442. The second conveyance path 332 is a conveyance path passing through a double-sided printing device 38 and is a conveyance path from the branch portion 442 to the confluence portion 441, which is different from the first conveyance path 331. The third conveyance path 333 is a conveyance path from the branch portion 442 to a discharge tray 20.

The sheet is extracted from a sheet stacking portion of any one of the paper feed cassette 161, the paper feed cassette 162, and a manual feeding tray 163. The sheet extracted from the sheet stacking portion temporarily stops at a portion where two registration rollers 31 are in contact with each other. At this point, the leading edge of the sheet abuts on the registration rollers 31 and the inclination of the sheet is corrected. The image forming control unit 100 starts the rotation of the registration rollers 31 according to the position of the toner image of the rotating intermediate transfer belt 21 and moves the sheet to the position of the secondary transfer roller 32.

The toner image formed on the intermediate transfer belt 21 is secondarily transferred to the sheet by the secondary transfer roller 32. The secondarily transferred toner image is fixed to the sheet by a fixing device 34. In this manner, the image is formed on the sheet by the control of the image forming control unit 100. The image forming control unit 100 conveys the sheet to which the toner image is fixed by the fixing device 34 to the third conveyance path 333 and discharges the corresponding sheet.

The wireless tag communication device 201 includes a computing device, a storage device, and an antenna (not illustrated). The wireless tag communication device 201 transmits a radio wave, for example, in an arrow k direction. The wireless tag communication device 201 communicates with the wireless tag provided on the sheet via the antenna. Specifically, the wireless tag communication device 201 reads the information from the wireless tag and writes the information to the wireless tag.

The wireless tag communication device 201 acquires the model number from the wireless tag. The wireless tag communication device 201 outputs the acquired information of the model number to the image forming control unit 100. The information that the wireless tag communication device 201 writes to the wireless tag is data included in the dispensing information. According to at least one embodiment, in the wireless tag communication device 201, a 860 MHz-960 MHz band radio wave (Ultra High Frequency: UHF) is used, for example. However, the RFID method and the frequency band are not limited to the embodiment, and other methods and frequency bands can also be employed.

The wireless tag according to the present embodiment is a radio frequency identifier (RFID) tag. Specifically, the wireless tag is a wireless tag of EPC Class-1 Generation-2 standard. The wireless tag in this standard has four memory banks of Banks 0 to 3.

Bank 0 is a “reserved bank”, and is a data area where, for example, a password for restricting the access to the memory is stored.

Bank 1 is an “EPC bank” and is a data area where an Electronic Product Code (EPC) is stored. The EPC is an abbreviation for GS1 identification code to be written to a standardized wireless tag.

Bank 2 is a “TID bank” and is a data area where a tag manufacturer stores the identification information of the tag. The information of the model number used in at least one embodiment is stored in the “TID bank”.

Bank 3 is a “User bank”, and is a data area that a user can freely use, for example.

Subsequently, the internal configuration of the image forming control unit 100 is described.

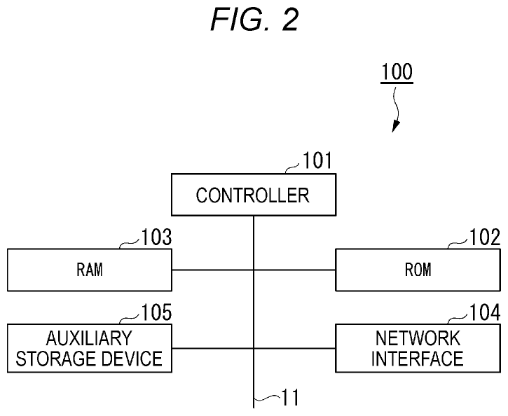

FIG. 2 is a block diagram illustrating an internal configuration of the image forming control unit 100 according to the first embodiment.

The image forming control unit 100 includes a controller 101, a read only memory (ROM) 102, a random access memory (RAM) 103, a network interface 104, and an auxiliary storage device 105. Each component is connected to each other via a system bus 11 so that data communication can be performed.

The controller 101 is, for example, a processor such as a central processing unit (CPU) or a graphics processing unit (GPU). An Application Specific Integrated Circuit (ASIC) may perform an appropriate function realized by the controller 101. As known in the art, the ASIC is a dedicated circuit for realizing a specific function. The controller 101 controls an operation of each functional unit of the image forming device 10. The controller 101 performs various processes by loading a program stored in the ROM 102 in the RAM 103 and executing the program.

If the dispensing condition is not satisfied, the controller 101 performs a warning process based on the model number and the model number included in the dispensing information. Specifically, the controller 101 performs a warning process if the model number included in the dispensing information and the model number acquired by the wireless tag communication device 201 do not agree with each other. In this manner, the dispensing condition according to the first embodiment is that the model numbers agree with each other.

The ROM 102 stores the program for operating the controller 101. The RAM 103 is a memory for temporarily storing data included in the image forming device 10 and used by each functional unit. The RAM 103 may temporarily store print data.

The network interface 104 transmits and receives data to and from the outside. Here, the outside is, for example, an external recording medium or an external communication device. The network interface 104 operates as an input interface and receives the print data transmitted from the outside. The print data transmitted from the outside is, for example, data stored in a portable document format (PDF). The dispensing information is stored in metadata of the print data. The network interface 104 operates as an output interface and transmits the error information to the external communication device.

The auxiliary storage device 105 is, for example, a hard disk or a solid state drive (SSD). The auxiliary storage device 105 stores various kinds of data. The various kinds of data stored by the auxiliary storage device 105 are, for example, print data, a job, a job log, and dispensing information.

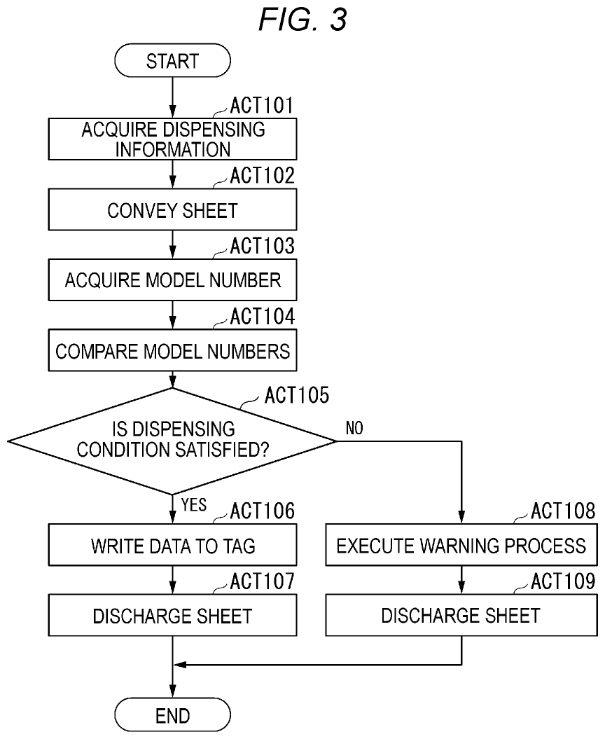

FIG. 3 is a flowchart illustrating a flow of the warning process performed by the image forming device 10 according to the first embodiment. The process of FIG. 3 is performed if the user instructs dispensing the sheet.

The network interface 104 acquires print data by performing communication with the external recording medium or the communication device. The network interface 104 outputs acquired print data to the controller 101. The controller 101 acquires the dispensing information from the metadata of the print data output from the network interface 104 (ACT 101).

The controller 101 controls the plurality of conveyance rollers and conveys the sheet to the conveyance path 33 (ACT 102). The controller 101 starts the transmission of signals (carrier waves), which may include query commands and read commands, at a regular interval and also starts the reception of response waves from the wireless tag by controlling the wireless tag communication device 201. Since the transmission side provides a signal, a response may be matched from a tag providing the signal.

If the sheet is conveyed within the communicable range of the wireless tag communication device 201, the communication is performed between the wireless tag communication device 201 and the wireless tag provided in the sheet. Accordingly, the wireless tag communication device 201 acquires the model number stored in the wireless tag (ACT 103). The wireless tag communication device 201 outputs the acquired information of the model number to the controller 101.

The controller 101 compares the model number included in the dispensing information with the model number output from the wireless tag communication device 201 (ACT 104). The controller 101 determines whether the dispensing condition is satisfied (ACT 105). The dispensing condition according to the first embodiment is where the model numbers match.

Here, the controller 101 determines that the dispensing condition is satisfied, if the model number included in the dispensing information and the model number output from the wireless tag communication device 201 agree with each other. The controller 101 determines that the dispensing condition is not satisfied if the model number included in the dispensing information and the model number output from the wireless tag communication device 201 do not agree with each other.

If the dispensing condition is satisfied (ACT 105: YES), the controller 101 controls the wireless tag communication device 201 and writes data to the wireless tag (ACT 106). Specifically, first, the controller 101 acquires the write data included in the dispensing information. The controller 101 controls the wireless tag communication device 201 and writes the acquired write data to the wireless tag. The wireless tag communication device 201 writes write data to the wireless tag according to the control of the controller 101. Accordingly, the data is written to the wireless tag.

The controller 101 controls a plurality of conveyance rollers and discharges the sheet to the discharge tray 20 (ACT 107). If the image forming on the sheet is required, the controller 101 controls the printer unit 18 and forms the image on the sheet. The information is written to the wireless tag provided on the sheet discharged in the process of ACT 107. To the wireless tag on the sheet discharged in the process of ACT 107, the information is already written by the process of ACT 106.

If the dispensing condition is not satisfied in the process of ACT 105 (ACT 105: NO), the controller 101 performs the warning process (ACT 108). Specifically, first, the controller 101 controls the wireless tag communication device 201 so that data is not written to the wireless tag.

For example, the controller 101 may control the wireless tag communication device 201 by not outputting the write data to the wireless tag communication device 201 so that the data is not written. The controller 101 controls the wireless tag communication device 201 by not performing instruction of writing to the wireless tag communication device 201 so that the data is not written.

Subsequently, the controller 101 displays the error information by controlling the display unit. Specifically, the controller 101 displays the notification that the dispensing condition is not satisfied and the reason why the dispensing condition is not satisfied on the display unit (display). According to the first embodiment, examples of the reason why the dispensing condition is not satisfied include that the model numbers are different from each other. The controller 101 controls the network interface 104 and transmits the error information to the designated external communication device. The controller 101 may sound a buzzer to notify that there is an error.

Thereafter, the controller 101 controls a plurality of conveyance rollers and discharges the sheet to the discharge tray 20 (ACT 109). If the image forming to the sheet is required, the controller 101 controls the printer unit 18 so that the image is formed on the sheet. The information is not written to the wireless tag provided on the sheet discharged in the process of ACT 109.

With respect to the image forming device 10 according to the first embodiment configured as described above, the writing failure to the wireless tag can be previously prevented before writing is attempted. Specifically, the image forming device 10 acquires the model number from the wireless tag provided in the sheet. The image forming device 10 acquires the dispensing information and performs the warning process based on the acquired dispensing information and the model number if the dispensing condition is not satisfied. Accordingly, before the writing to the wireless tag, it is possible to determine whether the dispensing condition is satisfied. Also, the image forming device 10 performs the warning process if the dispensing condition is not satisfied. As a result, it is possible to warn the user before writing to the wireless tag. Therefore, it is possible to previously prevent the writing failure to the wireless tag.

The image forming device 10 performs the warning process to notify that the dispensing condition is not satisfied if the model number included in the dispensing information and the model number acquired by the wireless tag communication device 201 do not agree with each other. Accordingly, it is possible to detect the disagreement between the wireless tag provided in the sheet and the wireless tag to be the writing target of the data provided in the dispensing information. Also, the image forming device 10 can detect the disagreement and notify the user of the disagreement. Therefore, it is possible to previously prevent the writing failure to the wireless tag.

### Second Embodiment

According to the first embodiment, it is likely that data cannot be written to the wireless tag when the model numbers are different from each other. Even if the model numbers are different from each other, if the characteristics of the wireless tags are the same, there is no particular influence by the writing. Here, according to a second embodiment, whether the dispensing condition is satisfied is determined based on the characteristics of the wireless tags.

The image forming device according to the second embodiment is basically the same as the configuration of the image forming device of the first embodiment. Hereinafter, configurations different from those in the first embodiment are described.

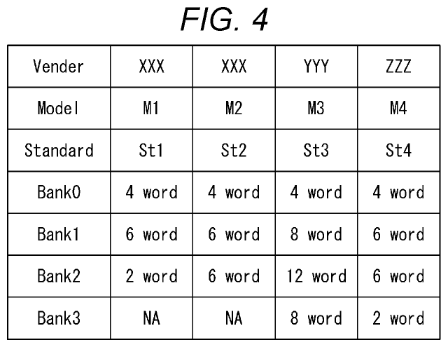

According to the second embodiment, the auxiliary storage device 105 stores the characteristic information on a per wireless tag type basis. The characteristic information is information relating to the characteristics of the wireless tag. For example, the characteristic information includes information such as a vendor, a model, a standard version, and a capacity of each memory bank. The auxiliary storage device 105 may store the characteristic information in a characteristic information table provided in FIG. 4.

FIG. 4 is a diagram illustrating an example of the characteristic information table in which the characteristic information is registered according to the second embodiment.

In the characteristic information table, venders, models, standards, and information of Banks 0 to 3 are registered on a per wireless tag type basis. Information on the manufacturer of the wireless tag is registered in the item of Vender. For example, in FIG. 4, in the item of Vender, three manufacturers of “XXX”, “YYY”, and “ZZZ” are registered as the manufacturers of the wireless tag.

In the item of Model, the information of models of the wireless tag (type) is registered. For example, in FIG. 4, in the item of Model, four kinds of models of “M1”, “M2”, “M3”, and “M4” may be registered as the models of the wireless tag.

In the item of Standard, the information of the version of the standard of the wireless tag is registered. For example, in FIG. 4, in the item of Standard, four kinds of standards of “St1”, “St2”, “St3”, and “St4” are registered as the versions of the standard. In the above description, the versions are older in the order of “St1”, “St2”, “St3”, and “St4”. Therefore, “St1” is the oldest version, and “St4” is the newest version.

In the items of Banks 0 to 3, the information on the capacity of each memory bank of the wireless tag is registered. That is, in the items of Banks 0 to 3, writable size information for each memory bank is registered. Banks 0 to 3 are a “reserved bank”, an “EPC bank”, a “TID bank”, and a “user bank” in the order from O. The expression “NA” in Bank 3 is an abbreviation of “Not Applicable”. This information is registered in the characteristic information table in advance.

The characteristic information registered on the first in the characteristic information table is characteristic information of the wireless tag of Vender “XXX”. For example, in the example illustrated in FIG. 4, Model is “M1”, Standard is “St1”, Bank 0 is “4 words”, Bank 1 is “6 words”, Bank 2 is “2 words”, and Bank 3 is “NA”.

That is, the wireless tag is the model of “M1”, the version of the standard is “St1”, the capacity of Bank 0 is for “4 words”, the capacity of Bank 1 is for “6 words”, the capacity of Bank 2 is for “2 words”, and there is no capacity of Bank 3.

The following information may be included in the metadata of the print data acquired by the network interface 104 according to the second embodiment, in addition to the model number and the write data to the wireless tag. For example, the information of the version of the standard, the information of the memory bank, and the information of the write size for each memory bank are further included in the metadata of the print data.

According to the second embodiment, the controller 101 acquires the corresponding characteristic information from the characteristic information table based on the model number output from the wireless tag communication device 201. For example, the controller 101 acquires the characteristic information that agrees with the model number.

The controller 101 may compare the version information of the wireless tag included in the acquired characteristic information with the version information of the wireless tag included in the dispensing information. Hereinafter, the information included in the characteristic information is described as characteristic OO information. For example, the version information of the wireless tag included in the characteristic information is described as characteristic version information. Hereinafter, the information included in the dispensing information is described as dispensing OO information. For example, the version information of the wireless tag included in the dispensing information is described as dispensing version information.

If the version indicated in the dispensing version information is higher than the version indicated in the characteristic version information, the controller 101 may determine that the dispensing condition is not satisfied. Hereinafter, the version indicated in the dispensing version information is described as the dispensing version. Hereinafter, the version indicated in the characteristic version information is described as the characteristic version.

If the dispensing version is equal to or lower than the characteristic version, the controller 101 compares the characteristic size information with the dispensing size information. If the size indicated in the dispensing size information is larger than the size indicated in the characteristic size information, the controller 101 performs the warning process for notifying that the dispensing condition is not satisfied. The controller 101 compares and determines the sizes with respect to each of Banks 0 to 3. In this manner, the dispensing condition according to the second embodiment is that the characteristic version is equal to or higher than the dispensing version, and the size included in the characteristic information is equal to or higher than the size included in the dispensing information.

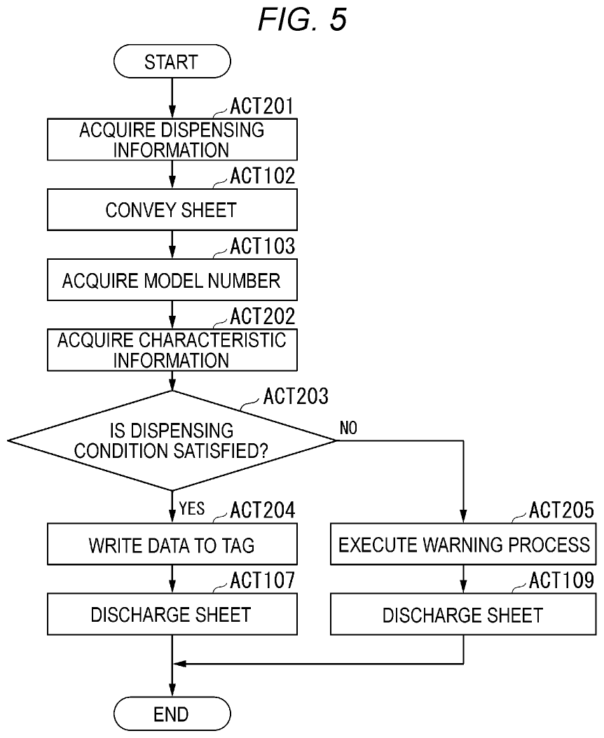

FIG. 5 is a flowchart illustrating a flow of the warning process performed by the image forming device 10 according to the second embodiment. The process of FIG. 5 is performed if the user instructs the dispensing of the sheet. In FIG. 5, the same processes as in FIG. 3 are denoted by the same reference numerals, and the descriptions thereof are omitted.

The network interface 104 acquires the print data by performing communication with the external recording medium or the communication device. The network interface 104 outputs the acquired print data to the controller 101. The controller 101 acquires the dispensing information from the metadata of the print data output from the network interface 104 (ACT 201).

Here, the controller 101 acquires the following information as the dispensing information.
Version of standard “St1”
Write size information to Bank 0 “4 words”
Write size information to Bank 1 “6 words”
Write size information to Bank 3 “2 words”

The controller 101 acquires the model number output from the wireless tag communication device 201 in the process of ACT 103. Here, the controller 101 acquires “M3” as the model number. The controller 101 reads the characteristic information table stored in the auxiliary storage device 105. The controller 101 acquires the corresponding characteristic information from the read characteristic information table by using the acquired model number (ACT 202).

Since the acquired model number is “M3”, the controller 101 acquires the following information as the characteristic information.
Vender “YYY”
Version of standard “St3”
Bank 0 size “4 words”
Bank 1 size “8 words”
Bank 2 size “12 words”
Bank 3 size “8 words”

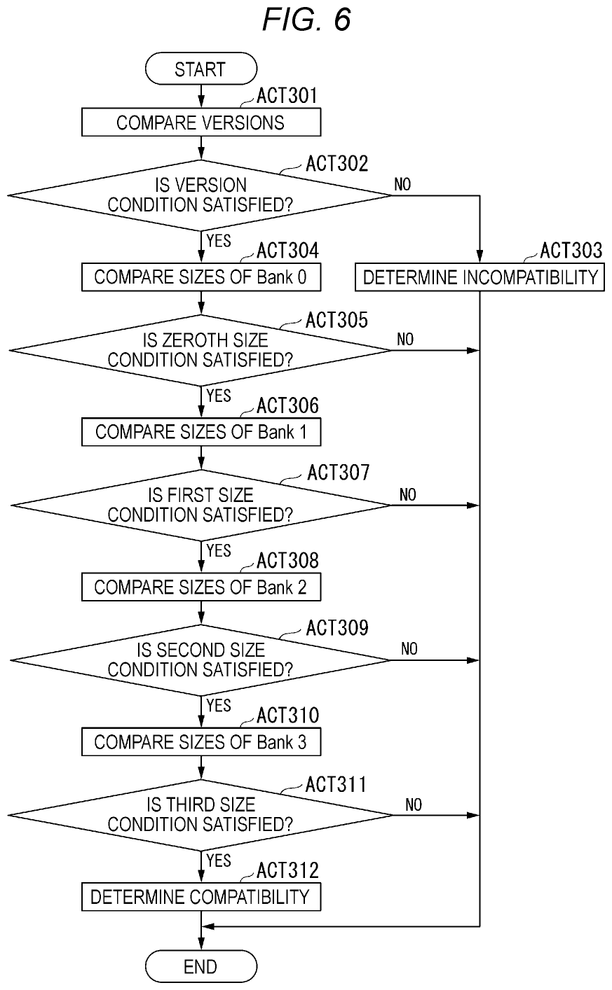

The controller 101 determines whether the dispensing condition is satisfied based on the acquired characteristic information and the acquired dispensing information (ACT 203). According to the second embodiment, the dispensing condition is that the characteristic version is equal to or higher than the dispensing version, and the size included in the characteristic information is equal to or larger than the size included in the dispensing information. The specific process is described below by using FIG. 6.

If the dispensing condition is satisfied (ACT 203: YES), the controller 101 controls the wireless tag communication device 201 and performs the writing to the wireless tag (ACT 204). Specifically, first, the controller 101 acquires the write data included in the dispensing information. Also, the controller 101 controls the wireless tag communication device 201 and writes the acquired write data to the wireless tag. The wireless tag communication device 201 writes the write data to the wireless tag according to the control of the controller 101. Accordingly, the data is written to the wireless tag.

The controller 101 controls the plurality of conveyance rollers and discharges the sheet to the discharge tray 20 (ACT 107).

If the dispensing condition is not satisfied in the process of ACT 203 (ACT 203: NO), the controller 101 performs the warning process (ACT 205). Specifically, first, the controller 101 controls the wireless tag communication device 201 so that the data is not written to the wireless tag.

Subsequently, the controller 101 displays the error information by controlling the display unit. Specifically, the controller 101 displays the notification that the dispensing condition is not satisfied, and further displays the reason why the dispensing condition is not satisfied on the display unit. According to the second embodiment, examples of the reason why the dispensing condition is not satisfied include that the version or the size does not satisfy the condition included in the dispensing information.

For example, if all of the characteristic versions included in each of the acquired characteristic information are lower than the dispensing version, the controller 101 displays that the version does not satisfy the condition included in the dispensing information. With respect to the size, the controller 101 displays the size of which memory bank does not satisfy the condition.

Thereafter, the controller 101 controls the plurality of conveyance rollers and discharges the sheet to the discharge tray 20 (ACT 109).

FIG. 6 is a flowchart illustrating a flow of a determination process performed by the image forming device 10 according to the second embodiment.

The controller 101 compares the version included in the dispensing information with the version included in the characteristic information (ACT 301). For example, the controller 101 compares the version “St1” included in the dispensing information with the version “St3” included in the characteristic information.

The controller 101 determines whether the version condition is satisfied (ACT 302). The version condition is that the characteristic version is higher than the dispensing version. In the above example, the characteristic version “St3” is equal to or higher than the dispensing version “St1”. Therefore, the controller 101 determines that the characteristic version satisfies the version condition. Meanwhile, when the version condition is not satisfied, the controller 101 determines that the version condition is not satisfied.

If the version condition is not satisfied (ACT 302: NO), the controller 101 determines that the characteristic information is incompatible (ACT 303). That is, the controller 101 determines that the dispensing condition is not satisfied.

If the version condition is satisfied (ACT 302: YES), the controller 101 compares the size of Bank 0 (ACT 304). Specifically, the controller 101 compares the write size of Bank 0 included in the dispensing information with the size of Bank 0 included in the characteristic information.

The controller 101 determines whether a zeroth size condition is satisfied (ACT 305). The zeroth size condition is that the size of Bank 0 included in the characteristic information is equal to or larger than the write size of Bank 0 included in the dispensing information. If the write size of Bank 0 is not included in the dispensing information, the controller 101 may determine that the zeroth size condition is satisfied and may not perform ACTS 304 and 305. If the processes of ACTS 304 and 305 are not performed, the controller 101 performs the process of ACT 306.

In the above example, the size of Bank 0 included in the characteristic information is “4 words”, and the write size of Bank 0 included in the dispensing information is “4 words”. That is, the size of Bank 0 included in the characteristic information is equal to or larger than the write size of Bank 0 included in the dispensing information. Therefore, the controller 101 determines that the size of Bank 0 included in the characteristic information satisfies the zeroth size condition. If the zeroth size condition is not satisfied, the controller 101 determines that the zeroth size condition is not satisfied.

If the zeroth size condition is not satisfied (ACT 305: NO), the controller 101 determines that the characteristic information is incompatible (ACT 303). That is, the controller 101 determines that the dispensing condition is not satisfied.

If the zeroth size condition is satisfied (ACT 305: YES), the controller 101 compares the size of Bank 1 (ACT 306). Specifically, the controller 101 compares the write size of Bank 1 included in the dispensing information and the size of Bank 1 included in the characteristic information.

The controller 101 determines whether a first size condition is satisfied (ACT 307). The first size condition is that the size of Bank 1 included in the characteristic information is equal to or larger than the write size of Bank 1 included in the dispensing information. If the write size of Bank 1 is not included in the dispensing information, the controller 101 determines that the first size condition is satisfied and may not perform. ACTS 306 and 307. If the processes of ACTS 306 and 307 are not performed, the controller 101 performs the process of ACT 308.

In the above example, the size of Bank 1 included in the characteristic information is “8 words”, and the write size of Bank 1 included in the dispensing information is “6 words”. That is, the size of Bank 1 included in the characteristic information is equal to or larger than the write size of Bank 1 included in the dispensing information. Therefore, the controller 101 determines that the size of Bank 1 included in the characteristic information satisfies the first size condition. If the first size condition is not satisfied, the controller 101 determines as such.

If the first size condition is not satisfied (ACT 307: NO), the controller 101 determines that the characteristic information is incompatible (ACT 303). That is, the controller 101 determines that the dispensing condition is not satisfied.

If the first size condition is satisfied (ACT 307: YES), the controller 101 compares the sizes of Bank 2 (ACT 308). Specifically, the controller 101 compares the write size of Bank 2 included in the dispensing information with the size of Bank 2 included in the characteristic information satisfying the first size condition.

The controller 101 determines whether the second size condition is satisfied (ACT 309). The second size condition is that the size of Bank 2 included in the characteristic information is equal to or larger than the write size of Bank 2 of the dispensing information. If the write size of Bank 2 is not included in the dispensing information, the controller 101 may determine that the second size condition is satisfied and may not perform ACTS 308 and 309. If the processes of ACTS 308 and 309 are not performed, the controller 101 performs the process of ACT 310.

In the above example, the write size of Bank 2 is not included in the dispensing information. Therefore, the controller 101 determines that the size of Bank 2 included in the characteristic information satisfies the second size condition. If the second size condition is not satisfied, the controller 101 determines that the second size condition is not satisfied.

If the second size condition is not satisfied (ACT 309: NO), the controller 101 determines that the characteristic information is incompatible (ACT 303). That is, the controller 101 determines that the dispensing condition is not satisfied.

If the second size condition is satisfied (ACT 309: YES), the controller 101 compares the size of Bank 3 (ACT 310). Specifically, the controller 101 compares the write size of Bank 3 included in the dispensing information with the size of Bank 3 included in the characteristic information that satisfies the second size condition.

The controller 101 determines whether a third size condition is satisfied (ACT 311). The third size condition is that the size of Bank 3 included in the characteristic information is equal to or larger than the write size of Bank 3 included in the dispensing information (for example, “2 words”). If the write size of Bank 3 is not included in the dispensing information, the controller 101 may determine that the third size condition is satisfied and may not perform ACTS 310 and 311. If the processes of ACTS 310 and 311 are not performed, the controller 101 performs the process of ACT 312.

In the above example, the size of Bank 3 included in the characteristic information is “8 words”, and the write size of Bank 3 included in the dispensing information is “2 words”. That is, the size of Bank 3 included in the characteristic information is equal to or larger than the write size of Bank 3 included in the dispensing information. Therefore, the controller 101 determines that the size of Bank 3 included in the characteristic information satisfies the third size condition. If the third size condition is not satisfied, the controller 101 determines that the third size condition is not satisfied.

If the third size condition is not satisfied (ACT 311: NO), the controller 101 determines that the characteristic information is incompatible (ACT 303). That is, the controller 101 determines that the dispensing condition is not satisfied.

If the third size condition is satisfied (ACT 311: YES), the controller 101 determines that the characteristic information that satisfies the third size condition is compatible (ACT 312). That is, the controller 101 determines that the dispensing condition is satisfied.

The image forming device 10 configured as described above according to the second embodiment performs the warning process if the dispensing condition is not satisfied in the same manner as in the first embodiment. As a result, before writing to the wireless tag, the user can be warned. Therefore, it is possible to previously prevent the writing failure to the wireless tag.

The image forming device 10 according to the second embodiment determines whether the dispensing condition is satisfied based on the characteristics of the wireless tag. Accordingly, in case of using a substitute, the characteristic information of the wireless tag of the substitute may be merely added to the image forming device 10. By doing so, the wireless tag satisfying the dispensing condition can be simply increased. As a result, it is possible to reduce the problem that the writing to the wireless tag cannot be performed if the model numbers are different from each other.

A modification example of the second embodiment is described.

According to at least one embodiment, the configuration in which the controller 101 compares the sizes in the order of Banks 0, 1, 2, and 3. The controller 101 may compare and determine the sizes of Banks 0 to 3 in any order.

Hereinafter, a modification example common to the first and second embodiments is described.

The wireless tag is not limited to the wireless tag of EPC Class-1 Generation-2 standard. For example, any wireless tag may be used as long as the wireless tag is an RFID tag.

The function of the image forming device according to the above embodiment may be realized by a computer. In this case, the function may be realized by recording a program for realizing this function in a computer-readable recording medium and reading and executing the program recorded in this recording medium by a computer system. Here, the “computer system” described herein includes an OS and hardware such as peripheral devices. The “computer-readable recording medium” refers to a portable medium such as a flexible disk, a magneto-optical disk, a ROM, or a CD-ROM, or a storage device such as a hard disk built in a computer system. The “computer-readable recording medium” may include a recording medium that dynamically stores a program for a short period of time like a communication line when transmitting the program through a network such as the Internet or a communication line such as a telephone line or a recording medium that stores a program for a certain period of time like a volatile memory inside a computer system serving as a server or a client in that case. The program may be a program for realizing some of the functions described above or may be a program capable of realizing the functions described above in combination with a program already recorded in a computer system.

While certain embodiments have been described these embodiments have been presented by way of example only, and are not intended to limit the scope of the disclosure. Indeed, the novel embodiments described herein may be embodied in a variety of other forms: furthermore various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An image forming device comprising:
a wireless tag communicator configured to acquire identification information to identify a wireless tag provided in a sheet;
a printer configured to form an image on the sheet after the wireless tag communicator acquires identification information from the wireless tag in the sheet; and
a controller, including a processor, configured to:
acquire dispensing information required to write to the wireless tag,
determine whether a dispensing condition to permit dispensing is met based on the dispensing information and the acquired identification information, and
if the dispensing condition is not satisfied, provide a warning.

2. The device according to claim 1 further comprising a network interface configured to receive a print data, wherein the printer forms an image on the sheet based on the print data.

3. The device according to claim 2, wherein the print data includes the dispensing information.

4. The device according to claim 2, wherein the
print data includes writable size information, the wireless tag communicator acquires size information from the wireless tag, and
the controller is configured to compare the writable size information with the size information.

5. The device according to claim 1,
wherein the dispensing information at least includes a wireless tag model number, and
the controller is configured to determine a dispensing condition based on (i) the wireless tag model number and (ii) the acquired identification information.

6. The device according to claim 5,
wherein the controller is configured to determine whether the dispensing condition is met by determining whether the model number included in the dispensing information matches the acquired identification information.

7. The device according to claim 1, wherein the wireless tag communicator in contact with an outside surface of a cover of the image forming device.

8. The device according to claim 1, wherein the wireless tag communicator includes an antenna.

9. The device according to claim 2,
wherein the print data includes at least version information of the wireless tag,
the dispensing information includes at least the version information of the wireless tag, and
the controller is configured to:
perform the warning process for notifying that the dispensing condition is not satisfied upon a version of the wireless tag indicated by the version information of the wireless tag included in the dispensing information being higher than the version of the wireless tag indicated by the version information of the wireless tag included in the characteristic information.

10. The device according to claim 1, further comprising:
a display configured to display information,
wherein the controller is configured to display the warning.

11. The device according to claim 1, wherein the dispensing condition is satisfied upon a model number match of the acquired dispensing information and the acquired identification information.

12. The device according to claim 1, wherein the controller is configured to, upon the dispensing condition being satisfied, control the wireless tag communicator to write data to the wireless tag.

13. The device according to claim 12, wherein the controller is configured to control the wireless tag communicator to write data to the wireless tag before the printer forms the image on the sheet.

14. The device according to claim 1, wherein the controller is configured to, upon the dispensing condition not being satisfied, control the wireless tag communicator to not write data to the wireless tag.

15. The device according to claim 1, wherein the print data includes vendor information of wireless tags.

16. A warning method for an image forming device, the method comprising:
acquiring, via a wireless tag communicator, identification information to identify a wireless tag provided in a sheet;
acquiring dispensing information required to write to the wireless tag,
wherein upon a dispensing condition being satisfied, control the wireless tag communicator to write data to the wireless tag and form an image on the sheet by a printer;
wherein upon a dispensing condition not being satisfied, provide a warning process using the acquired dispensing information and the acquired identification information.

17. The method according to claim 16, further comprising:
receive a print data via a network, wherein the image is formed on the sheet based on the print data.

18. The method according to claim 17, wherein the print data includes the dispensing information.

19. The method according to claim 16, wherein the acquired identification information includes a model number of the wireless tag.

20. The method according to claim 19, wherein the dispensing condition is satisfied upon a model number match of the acquired dispensing information and the acquired identification information.
